(19) United States
(12) Patent Application Publication
(10) Pub. No.: US 2009/0226153 A1
(43) Pub. Date: Sep. 10, 2009

(54) METHODS AND SYSTEMS FOR STORING AND DECODING DATA

(75) Inventor: Alexander Libin, Tel Aviv (IL)

Correspondence Address: Pearl Cohen Zedek Latzer, LLP, 1500 Broadway, 12th Floor, New York, NY, 10036, US

(73) Assignee: Alexander Libin, Tel Aviv (IL)

(21) Appl. No.: 12/043,264

(22) Filed: Mar. 6, 2008

(51) Int. Cl. H04N 5/781

(52) U.S. Cl. 386/126

(57) ABSTRACT

An optical disc decoding system, the optical disc decoding system includes: (a) a data reading optical head that is adapted to read coded data from a data layer of a data optical disc; (b) a decoding information reading optical head, that is adapted to read decoding information from a fluorescent layer of a decoding optical disc; and (c) a processor, connected to the data reading optical head and to the decoding information reading optical head, and which is adapted to decode the coded data into decoded data in response to the decoding information.

### CONTINUATION IN PART

The invention is a continuation in part of international patent application number IL2007/000801, filed on 2 Aug. 2006 titled “Compact Optical Video Disc Player and a Method for Playing a Video Stream”.

### FIELD OF THE INVENTION

The invention relates to methods and systems for storing and decoding data.

### BACKGROUND OF THE INVENTION

Fluorescent Optical Disc is different in physical principle of action from all other optical discs that are based on the physical principle of the light reflection, such as DVD, CD, HD DVD, BD, VMD. The physical principle of action and ways if construction of the Fluorescent Multi layer Disc (FMD) are described in prior art, e.g. in U.S. Pat. No. 6,039,898 and U.S. Pat. No. 6,309,729. FMD Design and Information Retrieval are disclosed in U.S. Pat. No. 6,009,065 and in U.S. Pat. No. 6,992,965. FMD manufacturing procedures are disclosed in US 2001/048977 and in EP 1419047.

There is a need, as known to a person who is skilled in the art, to improve a content protection of the content of different types of optical discs—FMD, multi-discs as well as the content of the multi layer reflective optical disc, such as (though not limited to) Multi layer DVD (including two or more layers); two-layer, three-layer and multi layer HD DVD, two-layer and multilayer BD, VMD (Versatile Multi layer Disc), and so forth.

Single disc video players are known in the art. A standard single disc video player includes a single optical head. In such players video signals the single optical head reads the optical video disc to provide analog signals that are then converted to digital signals, digitally processed and eventually sent to one or more video output units such as a display, TV set and/or projector. The optical head is positioned above the spinning optical video disc by a servo. The optical video disc is spun by a rotating engine.

Content suppliers are facing various challenges. The first challenge is associated with the increasing volume of video files, especially high definition video files. The second challenge is associated with copyright infringements and especially the so-called industrial copyright piracy.

Blue-ray) disc and high definition digital optical video disc (HD DVD) are two emerging technologies which provide high capacity optical video discs. For example, a 12 cm single-sided single layer capacity Blue ray disc can store 25 Gigabyte and a 12 cm single-sided single layer capacity HD DVD disc can store 15 Gigabyte. In comparison, a 12 cm single-sided single layer capacity “older generation” disc can store 4.7 Gigabyte. Despite their increased volume the newer technologies (Blue-ray and HD DVD) require using relatively high cost HD players as well as new industrial infrastructure for Disc & drive manufacturing.

Industrial copyright piracy occurs when a vendor that was allowed to produce copies of a copyrightable optical video disc exceeded his quota and manufactures unauthorized copies of the optical video disc. These unauthorized copies are then sold without paying the copyright owner any royalties.

There is a growing need to provide systems and methods for storing and decoding data.

### SUMMARY OF THE INVENTION

An optical disc decoding system, the optical disc decoding system includes: (a) a data reading optical head that is adapted to read coded data from a data layer of a data optical disc; (b) a decoding information reading optical head, that is adapted to read decoding information from a fluorescent layer of a decoding optical disc; and (c) a processor, connected to the data reading optical head and to the decoding information reading optical head, and which is adapted to decode the coded data into decoded data in response to the decoding information.

A method for decoding, the method includes: (a) reading coded data from a data layer of a data optical disc; (b) reading decoding information from a fluorescent layer of a decoding optical disc; and (c) decoding the coded data into decoded data in response to the decoding information.

An optical disc, the optical disc includes: (a) at least one data layer, which includes coded data, and (b) a fluorescent layer, which includes decoding information, for the decoding of the coded data.

An optical discs system, including: (a) at least one data optical disc which includes at least one data layer that includes coded data, and (b) a decoding optical disc which includes a fluorescent layer, which includes decoding information for the decoding of the coded data.

### BRIEF DESCRIPTION OF THE DRAWINGS

The present invention will be understood and appreciated more fully from the following detailed description taken in conjunction with the drawings in which:

FIG. 1 illustrates a compact optical video disc player according to an embodiment of the invention;

FIG. 2 illustrates a compact optical video disc player according to another embodiment of the invention;

FIG. 3 illustrates a compact optical video disc player according to yet another embodiment of the invention;

FIG. 4 illustrates a compact optical video disc player according to yet another embodiment of the invention;

FIG. 5 is a timing diagram illustrating a retrieval of video content stored in a sequential manner, according to an embodiment of the invention;

FIG. 6 is a timing diagram that illustrates a retrieval of video content as well as the retrieval of metadata, according to an embodiment of the invention;

FIGS. 7-9b illustrate various video information allocations, according to various embodiments of the invention;

FIG. 10 is a flow chart of a method for playing a video stream, according to an embodiment of the invention;

FIG. 11 illustrates an optical disc, according to an embodiment of the invention;

FIG. 12 illustrate an optical discs system, according to an embodiment of the invention.

FIG. 13 illustrates a method for using at least one optical disc, according to an embodiment of the invention;

FIG. 14 illustrates an optical disc decoding system, according to an embodiment of the invention;

FIG. 15 illustrates an optical disc decoding system, according to an embodiment of the invention; and

FIG. 16 illustrates a method for decoding, according to an embodiment of the invention.

### DETAILED DESCRIPTION OF THE DRAWINGS

A compact optical video disc player and a method for playing a video stream are provided. Multiple optical video discs are stored within the compact optical video disc player. The multiple optical video discs can be read by multiple optical heads of the compact optical video disc player. The compact video disc player can be placed within a standard 1U PC box.

Conveniently, the number of optical video discs equals the number of optical heads.

Conveniently, the optical video discs store portions of one or more films.

Conveniently, the multiple optical video discs are placed in a cartridge and the cartridge (including the multiple optical video discs) are provided to (for example inserted into) the compact optical video disc player. The cartridge can have different shapes and can hold the optical video discs in various manners. For example—the optical video discs can be stacked, arranged in a two dimensional array, placed in a row.

Conveniently, the compact optical video disc player includes multiple optical heads as well as digital multiple video paths. Using multiple relatively components (typically in the digital domain) that can be shared by the cheap optical heads and sharing digital components can provide a low cost but high throughput compact optical video disc player.

The video information can be arranged in various manners. Different fragments of a video stream (for example—of a program) can be distributed among the multiple optical video discs in a sequential or non-sequential manner.

The usage of the video information can be secured by using conditional usage information. At least a portion of the conditional usage information can be stored on one or more of the optical video discs or can be stored in a memory unit that differs from the optical video discs.

Conveniently, each optical head and associated components can read optical video discs using so-called “older” generation DVD formats whereas the Red laser compact optical video disc player can play multiple optical video discs that can store a large amount of video information that can exceed the amount of data stored in current HD DVD and Blue-Ray discs, while Blue laser disc video player (based on Blue-ray or HD DVD servos and optical heads) could play Blue laser optical video discs, multiplying several times amount of data stored in current HD DVD and Blue-ray discs.

### Sample Video Player Configurations

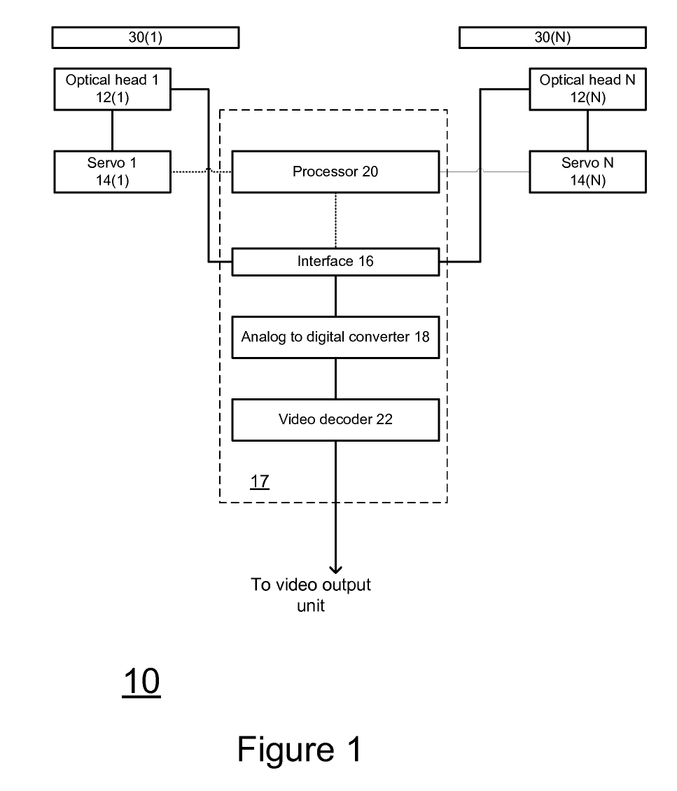

Analog signals generated by the optical heads are converted to digital signals that are processed to provide a video stream. The video stream is sent to a video output unit. This process can utilize shared components such as but not limited to a shared analog to digital converter, a shared video decoder, and the like video output unit FIG. 1 illustrates compact optical video disc player 10 according to an embodiment of the invention.

Compact optical video disc player 10 includes multiple optical heads 12(1)-12(N), multiple servos 14(1)-14(N), analog to digital converter 18, processor 20, video decoder 22 and an interface (referred to as commuter) 16. Analog to digital converter 18, processor 20, video decoder 22 and interface 16 form video processing unit 17. The compact optical video disc player can include an audio decoder and that processor 20 is connected to video decoder 22 and interface 22. For simplicity of explanation this audio decoder and various connections are not shown in FIG. 1.

It is noted that a single optical video disc stores only a portion of the video stream. For example, if each of the N optical video discs has a capacity of C1 then in order to store C films, the overall capacity of the optical discs should not be smaller than (N−1)*C1.

Optical heads 12(1)-12(N) read optical video discs 30(1)-30(N). These optical heads are connected to servos 14(1)-14(N) and to interface 16. Interface 16 includes multiple inputs that are connected to optical heads 12(1)-12(N) and an output that is connected to analog to digital converter 18. Analog to digital converter 18 is also connected to processor 20 and video decoder 22. Processor 20 controls the various servos 14(1)-14(N) and can also control interface 16 and, alternatively or additionally controls analog to digital converter 18. Processor 20 can control the servos according to a predefined retrieval algorithm, according to metadata retrieved from one or more optical video discs, metadata stored on a memory unit that differs from the optical video discs, or a combination thereof.

Processor 20 can select which optical head to activate, send appropriate control signals to the optical head and its associated servo, and can determine how to direct the analog signals generated from the optical head via interface 16 to analog to digital converter 18.

A sample retrieval algorithm can start by reading video information from the first optical head 12(1) and then read one optical video disc after the other, according to their order, until a completion of retrieval of data from the last optical video disc 30(N).

Interface 16 can multiplex between analog signals provided to different inputs (or gates) of interface 16. An optical head reads a certain optical video disc and generates analog signals that are sent to interface 16. Interface 16, following the order from the processor 20, selects which analog signal to pass to analog to digital converter 18 to provide a digital signal that is then sent to video decoder 22.

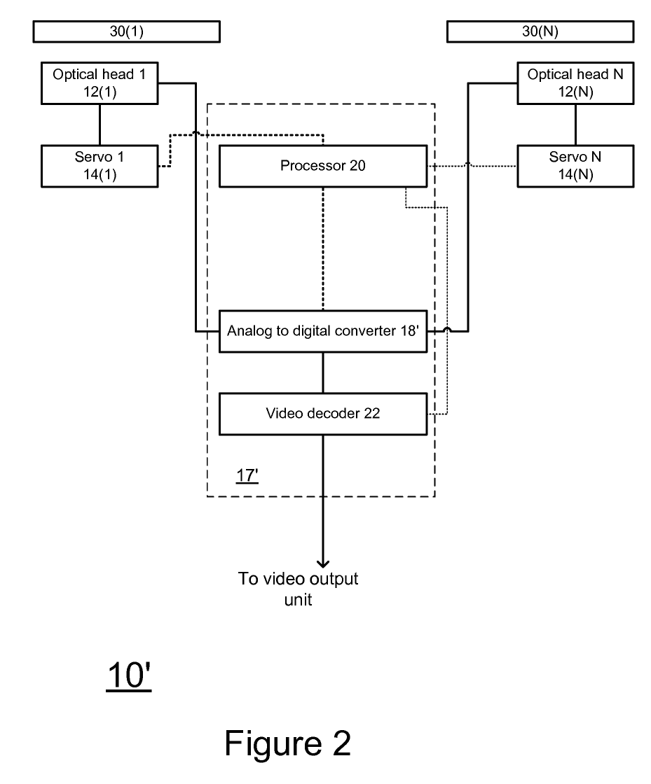

FIG. 2 illustrates compact optical video disc player 10′ according to another embodiment of the invention.

Compact optical video disc player 10′ of FIG. 2 differs from compact optical video disc player 10 of FIG. 1 by including a multiple-input analog to digital converter 18′ that is connected to the outputs of optical heads 12(1)-12(N). Analog to digital converter 18′, processor 20, video decoder 22 and interface 16, which multiplexes parallel information streams into a sequential one as a part of the transformation of the analogue signal into a digital one by the converter 18′, form video processing unit 17′.

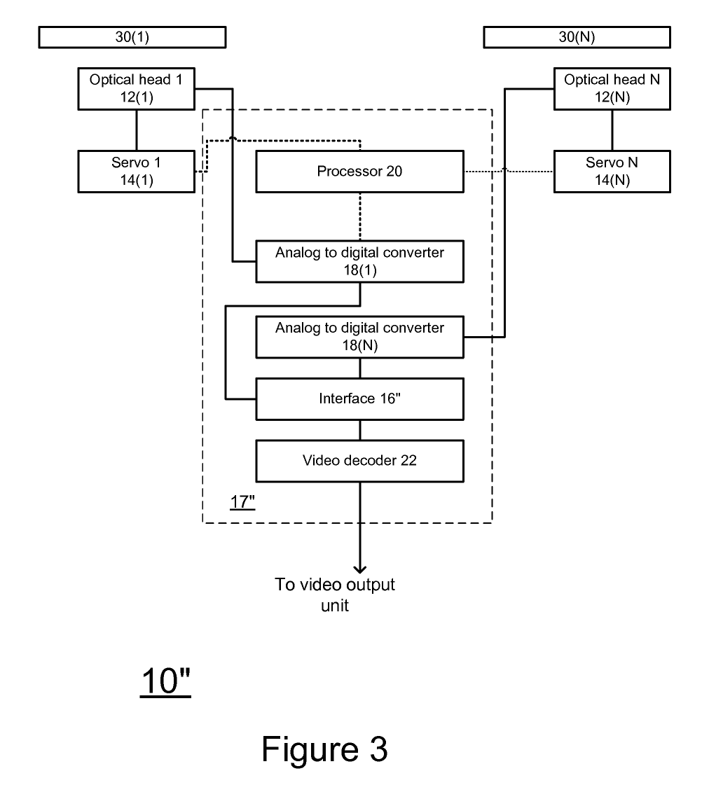

FIG. 3 illustrates compact optical video disc player 10″ according to yet another embodiment of the invention.

Compact optical video disc player 10″ of FIG. 3 differs from compact optical video disc player 10 of FIG. 1 by including multiple analog to digital converters 18(1)-18(N) instead of a single analog to digital converter 18. Each analog to digital converter is connected to an optical head and to interface 16′. Interface 16′ receives as input digital signals while interface 16 of FIG. 1 received analog signals. Analog to digital converters 18(1)-18(N), processor 20, video decoder 22 and interface 16 form video processing unit 17″.

Those of skill in the art will appreciate that the compact optical video disc player can include multiple optical heads and multiple shared components that are shared by few (but not all) the optical heads. For example, N optical heads can be connected to M analog to digital converters (1<M<N) that in turn are connected to a single interface.

It is noted that any of the mentioned above compact optical video disc players can include one or more buffers. Buffers can store digital signals that represent video content, can store control signals, metadata and the like. Using buffers can relax timing constraints associated (among other things) with a transition from one video path to another. A buffer can precede video decoder 22, can be included within video decoder 22, and the like.

It is further noted that the access to video content can be secured by using metadata received from another unit such as a memory unit that differs from the optical video discs. The other memory unit can be included within the compact optical video disc player or outside the compact optical video disc player. The other memory unit can be a removable memory unit (such as but not limited to a memory stick, memory card and the like. The memory stick can have a Universal Serial Bus (USB) interface but this is not necessarily so. It is further noted that various memory interfaces can connect a memory unit to processor 20. Sample interfaces include IDE ATAPI, SCSI but other interfaces can be used.

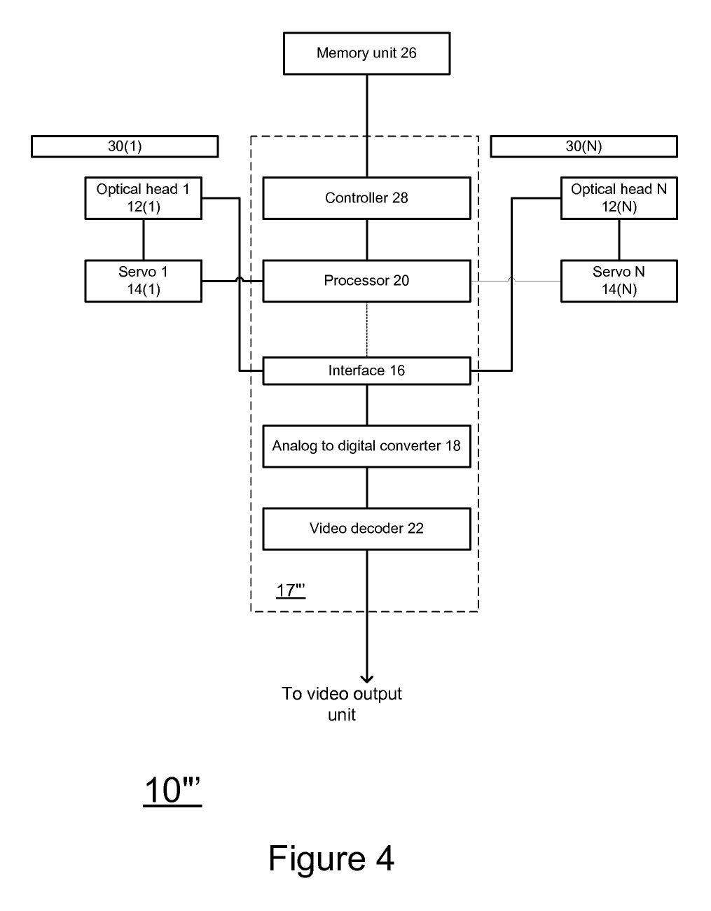

FIG. 4 illustrates compact optical video disc player according to a further embodiment of the invention. Compact optical video disc player 10′″ of FIG. 4 differs from compact optical video disc player 10 of FIG. 1 by including a controller 28 that is connected to processor 20 and is adapted to receive metadata from memory unit 26. Analog to digital converter 18, controller 28, processor 20, video decoder 22 and interface 16 form video processing unit 17′″.

### Sample Video Information Retrieval Algorithms

A video stream can be formed from multiple video stream fragments. A video stream fragment can be represented by one or more files stored on an optical video disc. According to various embodiments of the invention the multiple video stream fragments that form the video stream can be spread among various multiple optical video discs in various manners. For example, the video fragments of a video stream can be arranged in a sequential manner or in a non-sequential manner. In order to properly retrieve video content the optical video player retrieves fragment location information that can be stored in various manners. The fragment location information can be stored within one (or more) optical video discs, can be stored (or at least partially stored) within a memory unit that differs from optical video discs 30(1)-30(N), and the like. Fragment location information stored in a certain optical video disc can point to a video stream fragment located in another optical video disc, but this is not necessarily so.

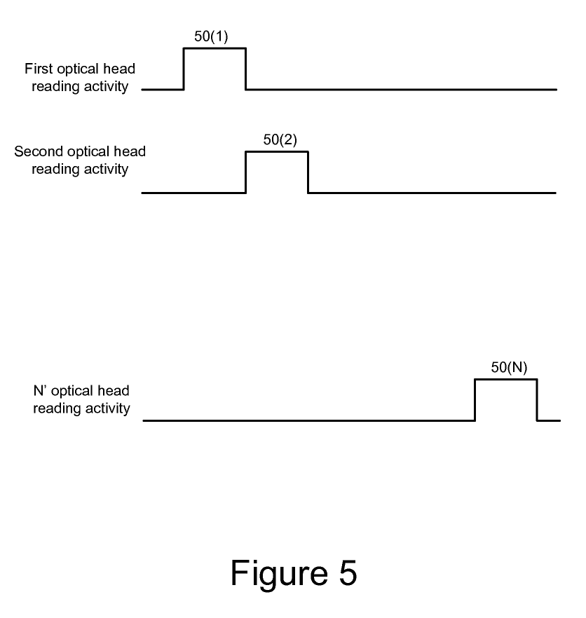

FIG. 5 is a timing diagram illustrating a retrieval of video content stored in a sequential manner, according to an embodiment of the invention. During the first till N′th time periods 50(1)-50(N) video information stored in the first till N′th optical video disc is retrieved.

It is further noted that video location information as well as additional metadata (also referred to as service information) can be retrieved while video information is retrieved. This can involve utilizing one or more optical heads concurrently. For example, while optical head 12(2) reads video content another optical head (for example—optical head 12(4)) can read metadata. This retrieval of two information streams can use time division multiplexing techniques, buffers, but this is not necessarily so.

The service information can include, for example, video manager code, which would perform, the change in the angle vision, change of languages, incorporation of the additional information, such as shooting data, actor's biographies etc., enabling additional graphic menu or interactive resources.

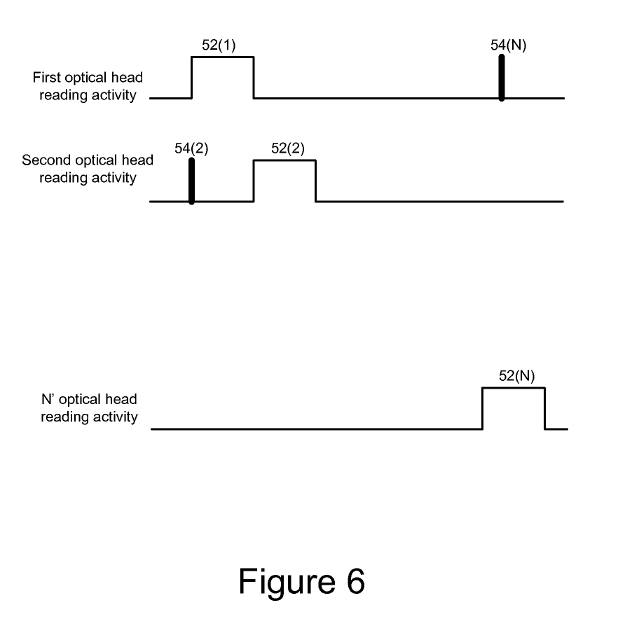

FIG. 6 is a timing diagram that illustrates a retrieval of video content as well as the retrieval of metadata, according to an embodiment of the invention.

While video information is retrieved by a certain optical head (illustrated by retrieval periods 52(1)-52(N), metadata can be retrieved by another optical head (as illustrated by metadata retrieval periods 54(1)-54(N)).

Yet according to another embodiment of the invention the video information is secured by using conditional usage information. The conditional usage information can prevent reading video information, performing analog to digital conversion, sending digital information to the video decoder, decoding digital video information or outputting decoded video information.

The conditional usage information can be stored on one or more optical video disc. This conditional usage information can also be stored on another memory unit. In order to enable the retrieval and/or processing of video information the conditional usage on the one or more optical video disc can be compared to the conditional usage information stored in the other memory unit. If the comparison is successful then the retrieval and/or processing of video information can be allowed. OK.

The conditional usage information can be allocated per video fragment, but this is not necessarily so. For example, video access information can be allowed per the whole video stream. 0

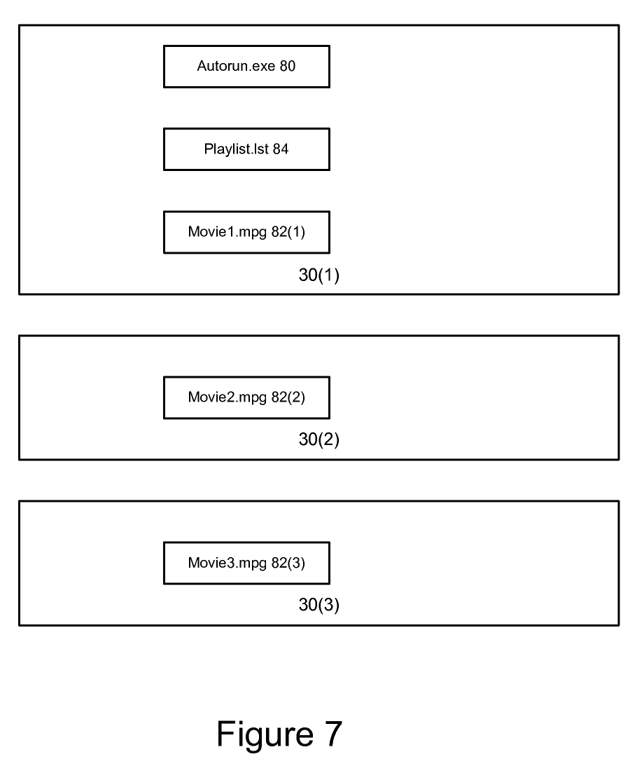

FIGS. 7-9 illustrate various video information allocations, according to various embodiments of the invention.

FIG. 7 illustrates a sequential arrangement of video files. An executable code that should be read at the start of the video playing process (denoted “autoran.exe” 80) is stored on first optical video disc 30(1). Video information is stored in three video files “movie1.mpg” “movie3.mpeg” 82(1)-82(3) are stored on three consecutive optical video discs 30(1)-30(3). Once the retrieval of first video file “movie1.mpg” 82(1) is completed the second video file “movie2.mpg” 82(2) is read. Once the retrieval of second video file “movie2.mpg” 82(2) is completed the third video file “movie3.mpg” 82(3) is read.

FIG. 7 also illustrates a file (denoted “playlist.1st” 84) that stores the locations of video files “movie1.mpg”-“movie3.mpg” 82(1)-82(3).

Playing the video files can include retrieving and executing “autorun.exe” 80 and then retrieving one video file after the other while using location information stored in “playlist.1st” 84.

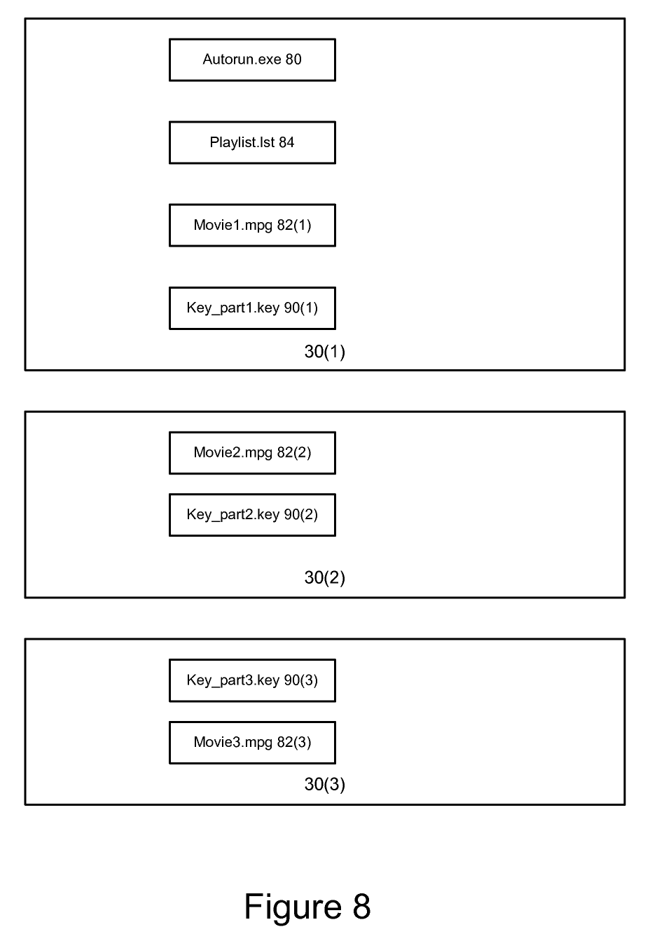

FIG. 8 illustrates a sequential arrangement of video files as well as multiple access information files. The multiple conditional usage information files “key_part1.ke”-“key_part3.ke” 90(1)-90(3) are stored in optical video discs 30(1)-30(3) respectively. All key parts should be retrieved and optionally compared to conditional usage information that is stored in another memory unit in order enable playback of the video content. Conveniently, after an initialization stage (or even during this stage) the compact optical video disc player retrieves different parts of the conditional usage information (also referred to as a coding key) that are located in one or more optical video discs.

The conditional usage information that is retrieved from the optical video discs is compared to conditional usage information stored in another memory unit.

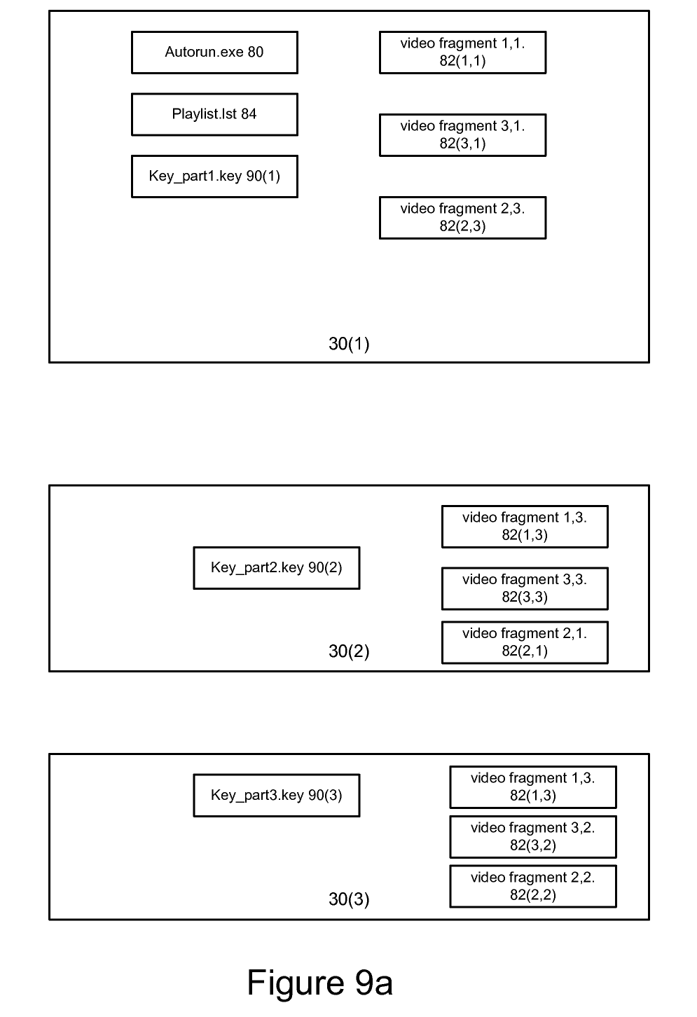

FIGS. 9a and 9b illustrate a non-sequential storage of video information. Different fragments 82(1,1)-82(3,3) of a video stream are spread in a non-sequential order among three optical video discs. The order and location of these video fragments should be passed to the processor in order to enable the proper retrieval of the video content. Fragment location information can be stored in various manners. It can be at least partially stored at a memory unit that differs from the optical video discs, but this is not necessarily so. At least a part of the fragment location information can be included in the conditional usage information.

According to an embodiment of the invention there are multiple predefined manners (or algorithms) for spreading the video fragments, and the fragment location information includes a value that selects between these possible manners.

According to another embodiment of the invention the fragment location information is encrypted and the conditional usage information includes a decryption key.

### Location of Lead in Information

A DVD includes a lead in area that includes lead in information. The lead in information should be read before video information (or so called “session” information) can be read. The lead in information includes control information.

Each DVD standard defines a predefined lead in area location. This enable the DVD player to start reading the lead in information once a DVD is inserted to the DVD player.

According to an embodiment of the invention the location of the lead in area can deviate from the standard location, while enabling a compact optical video disc player to retrieve the lead in information. The non-standard location of the lead in area can be stored in the compact optical video disc player during production. Additionally or alternatively, the non-standard location of the lead in area can be stored in a memory unit that differs from the optical video discs. OK.

The standard lead in area will include information that will be regarded by standard compact optical video disc player such as standard single disc DVD players as erroneous.

The lead in area can be shifted from the optical video disc center by 0.1-11.0 mm. Thus, it can be located in a annular area delimited by two imaginary coaxial circles having a radius of 23.2 mm and 23.8 mm. It is noted that the lead in area can be located in other locations. It is further noted that different optical video discs can include differently located lead in areas. OK.

### Loading Optical Video Discs

The multiple optical video discs can be loaded in various manners. According to one embodiment of the invention each out of the N optical video discs has its own loading mechanism. For example, the compact optical video disc player can include N slots, N sliding trays, and the like. These different loading mechanisms can be arranged in various manners such as but not limited to a stack, a two dimensional array or a row.

According to another embodiment of the invention a shared loading mechanism is used. Prior art DVD players include cassettes or other loading mechanisms that enable to store multiple DVDs (or multiple CDs) and load a single DVD to a DVD player. An example of such prior art mechanism is illustrated in U.S. Pat. No. 6,044,047 of Kulas. These loading mechanisms can be amended to enable the provision of multiple optical video discs to multiple locations accessible by the multiple optical video disc engines.

It is noted that FIG. 9b illustrates a file structure of the multi disc with the content “scrambling”. In case of the hybrid disc decoding files and keys are stored on the fluorescent CD layer. For example: autorun.exe, Playlist.1st, Key_part1.key, Key_partN.key, MouvieM1.mpg, MouvieMN.mpg etc.

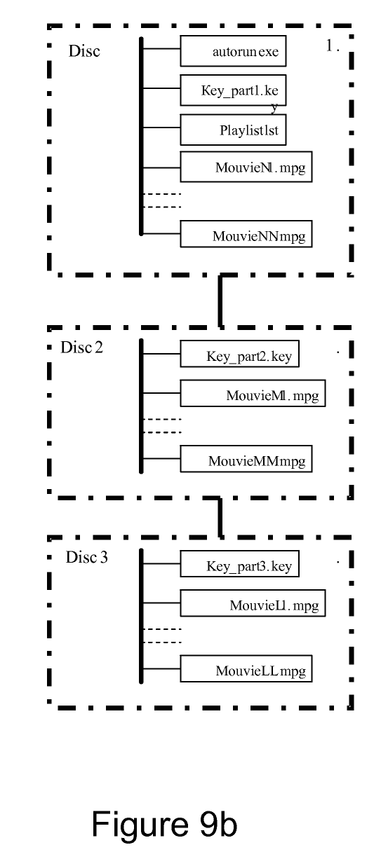

FIG. 10 is a flow chart of method 200 for playing a video stream according to an embodiment of the invention.

Method 200 starts by stage 220 of initializing the compact optical video disc player.

Stage 220 can include loading the multiple optical discs to the compact optical video disc player, connecting an external memory unit to the compact optical video disc player, reading lead in information or lead in location information, activating one or more optical heads, and the like. It is noted that optical heads can remain active (and maintain proper focus) even when then are not scheduled to read an optical disc. This can shorten the transition between one optical head to another.

Stage 220 can include searching lead in information in response to lead in location information stored on at least one optical video disc. The searching can include reading lead in location information from a memory unit that differs from the multiple optical video discs. Stage 220 can include reading lead in information located at a location that differs from a location of lead in information within optical video discs of standard optical video disc systems.

According to an embodiment of the invention stage 220 can also include retrieving conditional usage information stored at multiple optical video discs; and determining in response to the conditional usage information, whether to read video content from the optical video discs. The determining can include comparing conditional usage information stored at multiple optical video discs and conditional usage information stored at a memory unit that differs from the optical video discs; and determining, in response to the comparison, whether to read video content from the optical video discs. According to an embodiment of the invention

Stage 220 is followed by stage 230 of reading video stream fragments that are stored on optical video discs by a optical video discs player by utilizing multiple optical heads coupled to multiple servos.

Conveniently, stage 230 includes reading optical video discs that are formatted according to one of the following formats: DVD-5, DVD-9, DVD-10, DVD-18, HD-DVD, Blue Ray, VMD and FMD.

Stage 230 can include at least one of the following: (i) reading video content from the multiple optical video discs in a sequential manner; (ii) reading video content from the each optical video disc in a non-sequential manner; (iii) reading video fragments that are spread in a non-sequential manner among the multiple discs; (iv) retrieving video stream fragments in response to fragment location information; wherein at least a portion of the fragment location information is stored on at least one optical video disc; (v) retrieving video stream fragments in response to fragment location information; wherein at least a portion of the fragment location information is retrieved from a memory unit that differs from the multiple discs;

It is noted that while stage 230 is executed by a certain optical head another optical head can read other information. Thus, stage 230 can be executed in parallel to other stages. For example, method 200 can include locating, by an optical head, a video fragment while reading, by another optical head, another video fragment. Additionally or alternatively, method 200 can include reading metadata required for processing a video fragment while reading, by another optical head, the video fragment.

Stage 230 is followed by stage 240 of processing the video stream fragments to provide a video stream.

Stage 240 of processing can include at least one of the following or a combination thereof: (i) converting analog video stream signals to digital video stream signals by at least one analog to digital converter; wherein a number of optical heads exceeds a number of analog to digital converters; (ii) converting analog video stream signals to digital video stream signals by an analog to digital converter that comprises at least one output and multiple inputs; wherein a number of inputs of the digital to analog converter exceeds a number of outputs of the digital to analog converter; (iii) converting analog video stream signals to digital video stream signals by at least one analog to digital converter and decoding the digital video stream signals by at least one video decoder; wherein a number of analog to digital converters exceeds a number of video decoders.

Stage 240 is followed by stage 250 of sending the video stream to a video output unit. Stage 250 can include sending the video stream to a display that is proximate to the multiple optical heads. Thus, the compact optical video disc player can be connected to a screen that is located in proximity to compact optical video disc player.

Method 200 can include optional stage 260 of writing video content on multiple discs. This can occur when the optical video discs are also writable.

The present invention can be practiced by employing conventional tools, methodology and components. Accordingly, the details of such tools, component and methodology are not set forth herein in detail. In the previous descriptions, numerous specific details are set forth, in order to provide a thorough understanding of the present invention. However, it should be recognized that the present invention might be practiced without resorting to the details specifically set forth.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

It is noted that the compact optical video disc player, according to the teaching of the invention, includes: multiple optical heads adapted to read multiple optical video discs; multiple servos coupled to the multiple optical heads; and a video processing unit adapted to process video signals read from the multiple optical heads and to provide a video stream to a video output unit; wherein a single optical video disc stores only a portion of the video stream.

According to an embodiment of the invention, the video output unit is a screen and wherein the screen is located in proximate to the compact optical video disc player.

According to an embodiment of the invention, the compact optical video disc player is adapted to read optical video discs that are formatted according to a format selected from a group that consists of: DVD-5, DVD-9, DVD-10, DVD-18, HD-DVD, Blue Ray, VMD and FMD.

According to an embodiment of the invention, the compact optical video disc player is further adapted to write on multiple optical video discs.

According to an embodiment of the invention, the multiple optical heads are coupled to at least one analog to digital converter via an interface; wherein a number of optical heads exceeds a number of analog to digital converters.

According to an embodiment of the invention, the multiple optical heads are coupled to an analog to digital converter that comprises at least one output and multiple inputs; wherein a number of inputs of the digital to analog converter exceeds a number of outputs of the digital to analog converter.

According to an embodiment of the invention, the video processing unit comprises multiple digital to analog converters that are coupled to at least one video decoder; wherein a number of analog to digital converters exceeds a number of video decoders.

According to an embodiment of the invention, the compact optical video disc is adapted to read video content from the multiple optical video discs in a sequential manner.

According to an embodiment of the invention, the compact optical video disc player is adapted to read fragments of a video stream that are stored in a non-sequential manner within each optical video disc.

According to an embodiment of the invention, the compact optical video disc player is to read fragments of a video stream that are spread in a non-sequential manner among the multiple discs.

According to an embodiment of the invention, the compact optical video disc player is adapted to retrieve fragment location information and to retrieve video stream fragments in response to the fragment location information; wherein at least a portion of the fragment location information is stored on at least one optical video disc.

According to an embodiment of the invention, the compact optical video disc player is adapted to retrieve fragment location information and to retrieve video stream fragments in response to the fragment location information; wherein at least a portion of the fragment location information is stored on a memory unit that differs from the optical video discs.

According to an embodiment of the invention, the optical head is adapted to locate a video fragment to be read by that optical head after another video fragment is read while another optical head reads the other video fragment.

According to an embodiment of the invention, an optical head is adapted to read video data while another video head reads metadata required for processing the video data.

According to an embodiment of the invention, the video processing unit is adapted to retrieve lead in location information and in response to access a lead in area of a optical video disc.

According to an embodiment of the invention, the video processing unit is adapted to retrieve the lead in location information from a memory unit that differs from the video player discs.

According to an embodiment of the invention, the video processing unit is adapted to access the lead in that is located an a location that differs from a location of lead in information within optical video discs of single optical video disc systems.

According to an embodiment of the invention, the video processing unit is adapted to retrieve conditional usage information stored at multiple optical video discs; and determine, in response to the conditional usage information, whether to read video content from the optical video discs.

According to an embodiment of the invention, the video processing unit is adapted to compare conditional usage information stored at multiple optical video discs and conditional usage information stored at a memory unit that differs from the optical video discs.

According to an embodiment of the invention, the compact optical video disc player includes multiple spaced apart optical video disc holders, each adapted to hold a single optical video disc.

According to an embodiment of the invention, the compact optical video disc player includes a loading mechanism adapted to receive the multiple optical video discs and to distribute the multiple optical video discs between the multiple optical video disc holders.

A method for playing a video stream, according to an embodiment of the invention, includes: (a) reading video stream fragments that are stored on multiple optical video discs by a compact optical video discs player by utilizing multiple optical heads coupled to multiple servos; wherein a single optical video disc stores only a portion of the video stream; (b) processing the video stream fragments to provide a video stream; and (c) sending the video stream to a video output unit.

According to an embodiment of the invention, the sending includes sending the video stream to a display that is proximate to the multiple optical heads.

According to an embodiment of the invention, the reading includes reading optical video discs that are formatted according to a format selected from a group that consists of: DVD-5, DVD-9, DVD-10, DVD-18, HD-DVD, Blue Ray, VMD and FMD.

According to an embodiment of the invention, the method further includes writing video content on multiple discs.

According to an embodiment of the invention, the processing includes converting analog video stream signals to digital video stream signals by at least one analog to digital converter; wherein a number of optical heads exceeds a number of analog to digital converters.

According to an embodiment of the invention, the processing includes converting analog video stream signals to digital video stream signals by an analog to digital converter that comprises at least one output and multiple inputs; wherein a number of inputs of the digital to analog converter exceeds a number of outputs of the digital to analog converter.

According to an embodiment of the invention, the processing includes converting analog video stream signals to digital video stream signals by at least one analog to digital converter and decoding the digital video stream signals by at least one video decoder; wherein a number of analog to digital converters exceeds a number of video decoders.

According to an embodiment of the invention, the reading includes reading video content from the multiple optical video discs in a sequential manner.

According to an embodiment of the invention, the reading includes reading video content from the each optical video disc in a non-sequential manner.

According to an embodiment of the invention, the reading includes reading video fragments that are spread in a non-sequential manner among the multiple discs.

According to an embodiment of the invention, the method further includes retrieving fragment location information and wherein the reading comprises retrieving video stream fragments in response to the fragment location information; wherein at least a portion of the fragment location information is stored on at least one optical video disc.

According to an embodiment of the invention, the method further includes retrieving fragment location information from a memory unit that differs from the multiple discs and wherein the reading comprises retrieving video stream fragments in response to the fragment location information.

According to an embodiment of the invention, the method further includes locating, by an optical head, a video fragment while reading, by another optical head, another video fragment.

According to an embodiment of the invention, the method further includes reading metadata required for processing a video fragment while reading, by another optical head, the video fragment.

According to an embodiment of the invention, the reading includes searching lead in information in response to lead in location information stored on at least one optical video disc.

According to an embodiment of the invention, the method further includes reading lead in location information from a memory unit that differs from the multiple optical video discs and read the lead in response to the led in location information.

According to an embodiment of the invention, the reading includes searching lead in information located at a location that differs from a location of lead in information within optical video discs of single optical video disc systems.

According to an embodiment of the invention, the method further includes retrieving conditional usage information stored at multiple optical video discs; and determining in response to the conditional usage information, whether to read video content from the optical video discs.

According to an embodiment of the invention, the method further includes comparing conditional usage information stored at multiple optical video discs and conditional usage information stored at a memory unit that differs from the optical video discs; and determining, in response to the comparison, whether to read video content from the optical video discs.

According to an embodiment of the invention, the compact optical video disc player is adapted to receive a cartridge that holds multiple optical video discs.

According to an embodiment of the invention, a number of optical video discs equals a number of optical heads.

According to an embodiment of the invention, the method further includes receiving a cartridge that holds multiple optical video discs.

According to an embodiment of the invention, the method is carried out wherein a number of optical video discs equals a number of optical heads.

Besides standard DVD format, there exists the so called FMD (Fluorescent Multilayer Disc) format. This format differs by the basic physical principle of action, by the method of the information retrieval and by manufacturing procedures. The physical principle and MFD disc construction are described in U.S. Pat. No. 6,039,898 and in U.S. Pat. No. 6,309,729. The information retrieval device principle and design are described in U.S. Pat. No. 6,009,065 and in U.S. Pat. No. 6,992,965. The manufacturing procedures are described in US 2001/48977 and in EP 1419047.

In order to provide the MDD multi discs with individual protection one can make one of the DVD dual layer discs that consists of two binded substrates as a hybrid disc: one layer-standard reflective DVD and another-Fluorescent CD (or DVD) disc (i.e. a substrate, covered by a layer of the fluorescent material) of the standard CD (or DVD) memory capacity.

This disc might be manufactured by standard DVD-ROM and CD-R manufacturing equipment. Instead of the regular organic dye, involved in CD-R manufacturing a fluorescent dye should be used.

The information retrieval from the hybrid disc will be performed by a modified optical head. The latter would consist of a standard DVD optical head that would read the DVD layer and irradiate the CD fluorescent layer, and a fluorescent signal detector which is attached to this optical head. The fluorescent signal detector would consist of standard components with the exception of the dichroic mirror and the interferential filter.

As it had been explained, in a multidisc system video content might be “scrambled” with different parts being located on different discs, according to some algorithm. This would be done in a way that this algorithm as well as other information, which is indispensible for the retrieval and decoding of the video data, is located on the CD layer of the hybrid disc. This information from the CD layer might be retrieved at the beginning of the video reproduction as well as retrieved continuously while the video reproduction progresses.

An embodiment of the invention includes a hybrid multidisc system, when one of the dual layer discs consist of a standard reflective DVD disc (4.7 GB), binded with a fluorescent CD disc (670 MB), while a detector of fluorescent signals is attached to the respective optical head.

An embodiment of the invention includes the information, needed for the functioning and the decoding of the video content on the multi disc to be stored (partly or wholly) on the fluorescent CD disc (for example: autorun.exe, Playlist.1st, Key_part1.key, Key_partN.key, Mouvie M1.mpg, MouvieMN.mpg etc.).

An embodiment of the invention includes control keys which are stored on the fluorescent CD layer.

According to an embodiment of the invention, the key of the reading system is to be compared with the control key stored on the fluorescent CD layer and in case they are identical the retrieval of the video content starts with the algorithm stored on the fluorescent CD disc.

Industrial piracy of the disc content conveniently includes an ordering from a DVD manufacturer a first amount of discs with a film on it (e.g. one million copies). The disc manufacturer in a case of a piracy produces a second amount which is considerably larger than the first amount (e.g. two millions copies) and sell the remainder discs without any license.

An embodiment of the invention includes protecting content (such as films) on MDD Muti-Discs in the following way: writing a film data of the film on 3 (or 4) double layer discs. The content is “scrambled” between the discs according to the claims you had written. So, each separate disc is unreadable.

It is noted that following this embodiment of the invention facilitates ordering the 3 or 4 different discs from different manufacturers. It is clear to any person who is skilled in the art that in such situation, no one of manufacturers has any interest to produce extra discs, since they have no use of them.

An embodiment of the invention includes an individual anti piracy protection.

A known problem is the art is that nowadays people might make industrial copies from regular DVD discs and the problem of the individual protection of each and every DVD disc becomes more and more acute.

A regular CD or DVD disc is produced in the following

way: one takes a transparent polycarbonate substrate and presses upon it a nickel stamper-nickel disc with edges of 0.1 micron length; as a result on has “the pits”-indentations on the surface of the polycarbonate surface; then one sputters said surface with some metal. The disc is ready.

The pits are the information. To read the disc one rotates it and directs on it the laser beam. The latter is reflected in a different way from pits and from a smooth locus of the disc. The photo detector registers this difference. The first signal is 1 and the second 0. You have a sequence of one's and zeroes. This is so called reflective discs the photo detector registers a coherent reflected beam. The optics and electronics were chosen for this purpose.

These standard discs has one very severe limitation: due to metallic sputtering they can have at most two information layers.

To overcome these limitations, the so called fluorescent disc had been developed: one fills the pits with the organic fluorescent dye and no metal sputtering. The laser beam irradiates the pit and induces secondary Fluorescent radiation; a special photo detector registers the fluorescent signal. Since there is no sputtering, the disc is transparent and one can do it multilayer.

An embodiment of the invention includes making one layer of the multi-disc fluorescent CD disc and store there all the encoding information. It is noted that currently, nobody in the world can make a copy of the fluorescent disc, and thus the offered multi disc will be absolutely protected.

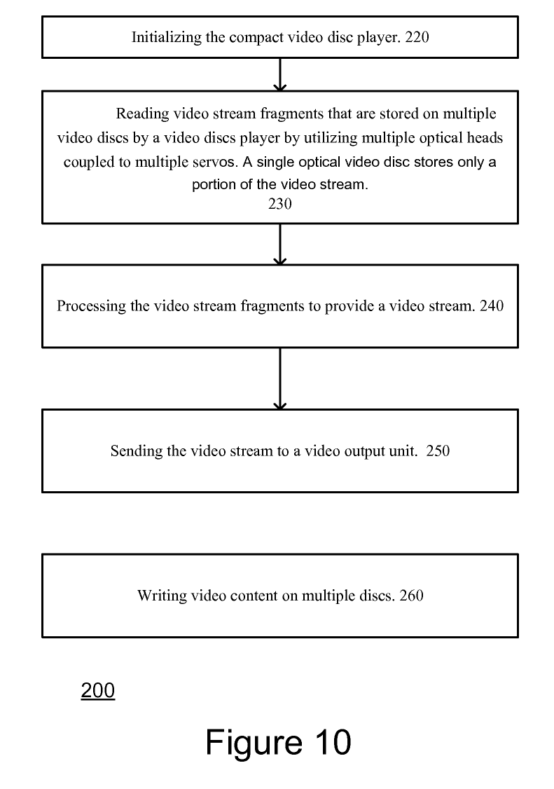

FIG. 11 illustrates optical disc 300, according to an embodiment of the invention. Optical disc 300 includes at least one data layer 310 (that is conveniently a reflective data layer) that includes coded data, and fluorescent layer 320 (which conveniently consist with FMD technology), which includes decoding information, for the decoding of the coded data.

According, optical disc 300 includes multiple data layers 310 that include the coded data which is scrambled between the multiple data layers 310; and fluorescent layer 320 includes decoding information for the reassembling of the scrambled data, scrambled between the multiple data layers 310.

It is noted that according to different embodiments of the invention, different types of decoding information are implemented (some of which are discussed above, in relation to other aspects of the invention), such as (though not limited to) encoding keys, decoding keys, encoding algorithms, decoding algorithms, and other service information, that enables the retrieval of the coded data.

According to an embodiment of the invention, a decoded data that is received from a decoding of coded data in response to the decoding information is a video data, e.g. similar to the video data discussed above.

It is noted that conveniently, optical disc 300 includes one or more bound substrates (not denoted), such as those needed in the manufacturing of data layers 310 and/or fluorescent layer 320.

According to an embodiment of the invention, optical disc 300 is a two-layer optical disc, which is made of two bound substrates, wherein a first substrate is a reflective optical disc (conveniently manufactured in a standard reflective optical disc technology, e.g. DVD or VMD), and a second substrate is a fluorescent disc. It is noted that, as the amount of the decoding information (and additional service information which may be needed according to some embodiments of the invention) is conveniently small, the fluorescent disc might be taken in CD format.

According to an embodiment of the invention, optical disc 300 is one of a two-layer, a three-layer or a multi layer HD DVD; a two-layer, a three-layer or a multi layer or BD, or similar multi disc system; wherein the fluorescent layer is a “blue” fluorescent layer.

According to an embodiment of the invention, a fluorescent substrate for fluorescent layer 320 is manufactured on a standard DVD-R or CD-R production line, wherein a fluorescent dye is used instead of an organic dye (for grooves in DVD-R).

According to an embodiment of the invention, fluorescent layer 320 (e.g. fluorescent CD layer) can be read by a standard DVD optical head. According to an embodiment of the invention, the at least one data layer 310 complies with the DVD standard as well, wherein, a DVD optical head is able to read both the reflective data layers 310 and fluorescent layer 320.

It is known in the art that the power and the contrast of the secondary fluorescent radiation from the pits with fluorescent composition is proportional to the pit volume, provided the laser beam diameter is bigger, than the pit width. This happens with CD format pit width and the distance between the tracks. According to an embodiment of the invention, a fluorescent dye of fluorescent layer 320 thus has the absorption maximum at a laser radiation of wavelength 650-660 nanometers (regular wavelength for DVD lasers).

According to an embodiment of the invention, fluorescent layer 320 (that is conveniently a “blue” fluorescent layer) includes a fluorescent dye having secondary radiation maximum substantially at 400 nanometer wavelength (standard for HD DVD and BD, e.g. as proposed in U.S. Pat. No. 7,087,283 B2 and in US Patent Application Publication US 2004/0085950 A1). It is noted that, according to an embodiment of the invention, the “blue” fluorescent layer is readable by a standard HD DVD optical head.

According to an embodiment of the invention, optical disc 300 includes two or more data layers 310 which comply with the HD-DVD standard, that are bounded to a fluorescent substrate which comply which either a CD or a DVD format, having pits filled by fluorescent composition with radiation maximum substantially at the wavelength of 400 nanometers.

It is noted that this hybrid optical disc 300 might be manufactured on the standard manufacturing equipment for HD DVD-ROM [symbol] HD DVD-R, DVD-R, CD-R. The production lines for HD DVD-R, DVD-R, CD-R are aimed at the manufacturing of the fluorescent substrate. In this equipment the dye for filling the grooves should be replaced by the fluorescent composition.

According to a similar embodiment of the invention, optical disc 300 complies with the BD standard: optical disc 300, including the at least one data BD layers 310, bounded with the “blue” fluorescent layer 320 that complies with the CD or the DVD format.

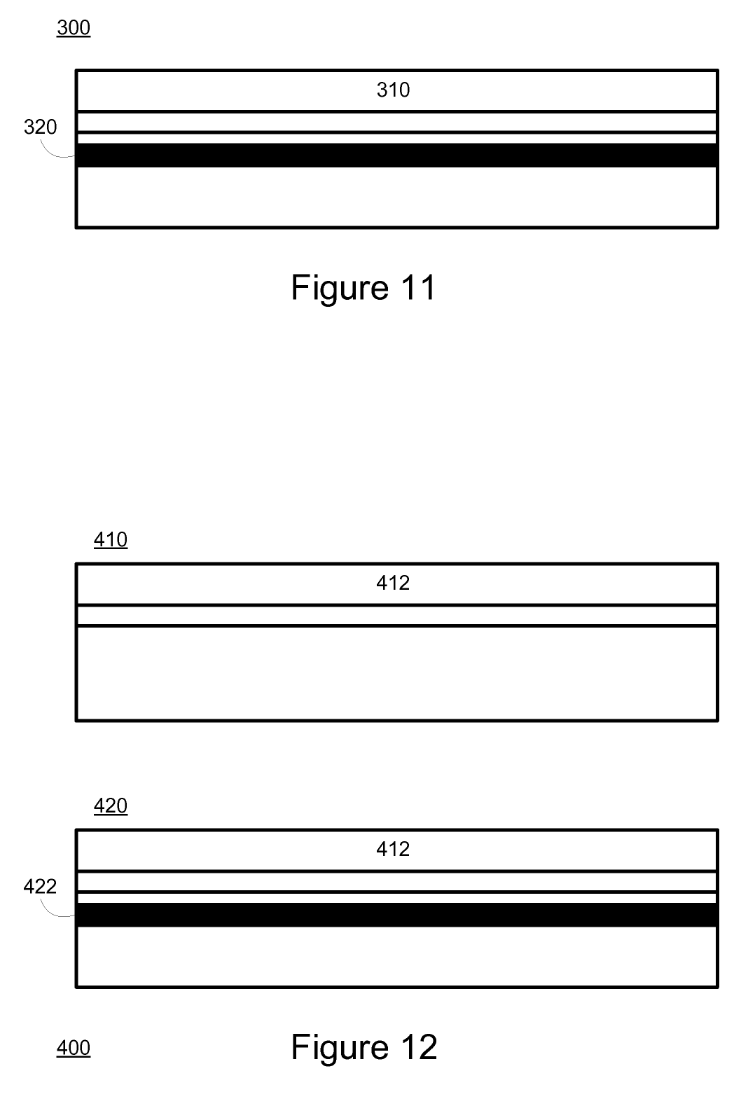

FIG. 12 illustrate an optical discs system, according to an embodiment of the invention. Optical discs system 400 includes at least one data optical disc 410 that includes at least one data layer 412 which includes coded data, and decoding optical disc 420 which includes fluorescent layer 422, which includes decoding information, for the decoding of the coded data. It is noted that, conveniently, decoding optical disc 420 also include at least one data layer 412.

According to an embodiment of the invention, wherein multiple data layers 412 of the at least one data optical disc 410 includes coded data which is scrambled between the multiple data layers 412 (which may be all included in a single data optical disc, or be distributed between multiple optical discs); wherein fluorescent layer 422 includes decoding information for the reassembling of the scrambled data.

It is noted that different embodiments of optical disc system 400 include optical discs 410 and 420 that correspond in one or more aspects to different embodiments of optical disc 300, as will be easily understood by a person who is skilled in the art.

It is noted that, according to an embodiment of the invention, at least one data layer 412 of optical disc system 400 include video content which can be partitioned and allocated on different optical discs 410 or on different layers of a multilayer disc according to some algorithm, while the information, concerning this algorithms well as other indispensable information for the information retrieval is to be located on fluorescent layer 422 (e.g. of a CD or a DVD formatted optical disc 420) layer (e.g. of a hybrid optical disc 300). This service information might be either retrieved at the start of reading or to be retrieved continuously.

According to an embodiment of the invention, a memory storage capacity on the one or more data layers 310 or 412 (that is a reflective layer) complies with one of the standard memory capacities of reflective layers (e.g. DVD-4, 7 GB, HD DVD-15 GB, BD-25 GB). According to an embodiment of the invention, a memory capacity of fluorescent layer 320 or 422 complies with a standard storage capacity (e.g. CD-670 MB, DVD-4,7 GB.)

According to an embodiment of the invention, a substantial part of the indispensable service information is written to fluorescent layer 320 or 422. For example: autorun.exe, Playlist.1st, Key_part1.key, Key_partN.key, MouvieM1.mpg, MouvieMN.mpg etc, discussed above.

According to an embodiment of the invention, controlling information (e.g. control keys) is written to fluorescent layer 320 or 422 (wherein the controlling information may facilitate the running and the decoding of at least one data layer 310 or 412).

According to an embodiment of the invention, a decoding of the coded data includes comparing a decoding key with the control key that is stored on fluorescent layer 320 or 422, while positive outcome enhances the information retrieval as well as the content decoding, the content being encoded by the same algorithm.

According to an embodiment of the invention, fluorescent layer 320 or 412 stores an essential part of the service information, concerned with the running and the decoding of the coded data, such as autorun.exe, Playlist.1st, Key_part1.key, Key_partN.key, MouvieM1.mpg, MouvieMN.mpg etc, discussed above.

According to an embodiment of the invention, the decoding of the coded data included comparing the control key and decoding the coded data with the control keys that are located on fluorescent layer 320 or 422, while positive outcome enhances the information retrieval as well as content decoding, the content being encoded by the same algorithm.

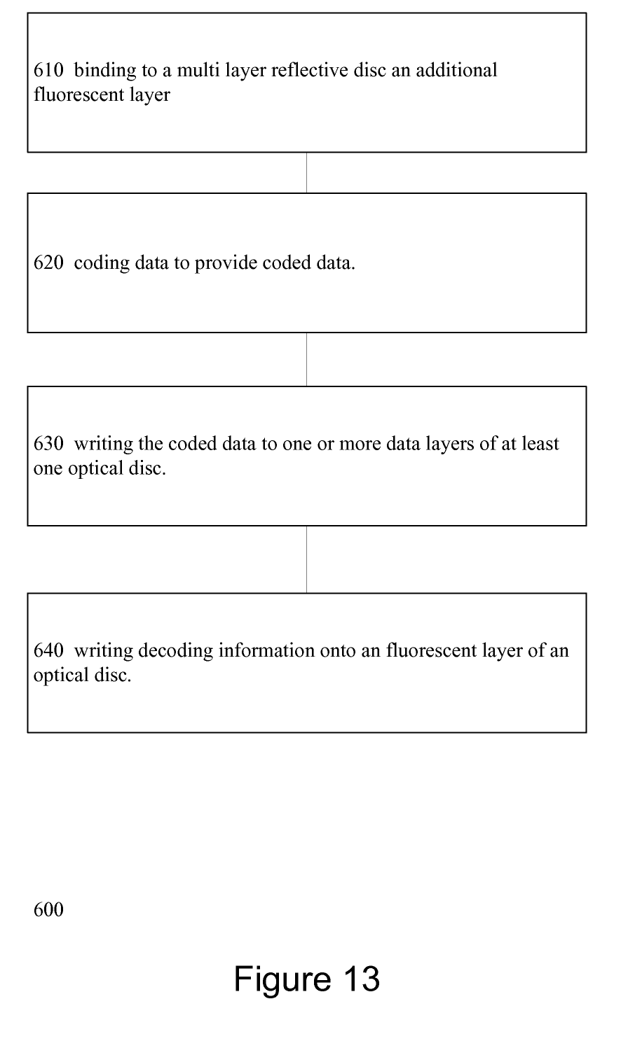

FIG. 13 illustrates method 600 for using at least one optical disc, according to an embodiment of the invention. It is noted that, according to different embodiments of the invention, method 600 might be applied as well to the content protection of optical discs 300, such as multilayer DVD discs, HD DVD-two layers, HD DVD-three layers, BD-two layers, multilayer HD DVD discs, multilayer BD discs, VMD as well as other possible multilayer disc formats.

According to an embodiment of the invention, method 600 starts with stage 610 of binding to a multi layer reflective disc an additional fluorescent layer (e.g. in CD or DVD format).

According to an embodiment of the invention, Stage 610 is followed by stage 620 of coding data to provide coded data. According to an embodiment of the invention, stage 620 includes scrambling content files.

Method 600 continues with stage 630 of writing the coded data to one or more data layers of at least one optical disc. According to an embodiment of the invention, stage 630 includes writing scrambled content files into multiple data layers of one or more optical discs.

Stage 630 is followed by stage 640 of writing decoding information (e.g. all the service information as well as the decoding algorithms) onto an fluorescent layer of an optical disc. According to an embodiment of the invention, stage 640 includes writing the decoding information onto one or more fluorescent layers of at least one optical disc.

It is noted that, conveniently, the reading optical disc is facilitated by increasing (e.g. by more than 2 Mbytes) a buffer memory of a drive controller of the reading system. This conveniently insures the information retrieval continuity in time of the laser layer switching.

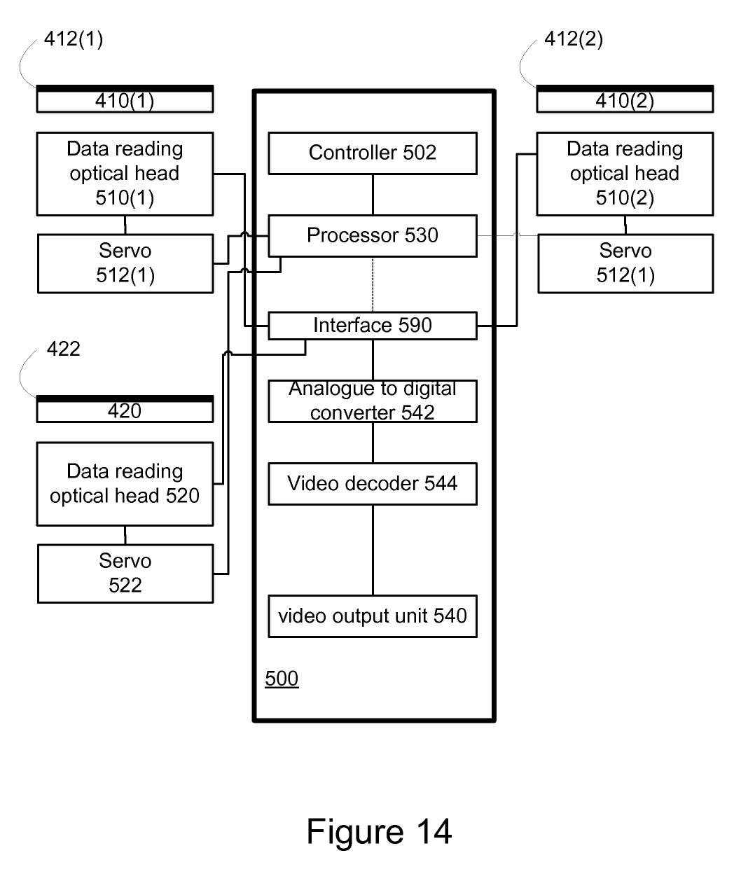

FIG. 14 illustrated optical disc decoding system 500, according to an embodiment of the invention. Optical disc decoding system 500 includes: (a) data reading optical head 510 that is adapted to read coded data from a data layer of a data optical disc 410; (b) decoding information reading optical head 520 that is adapted to read decoding information from a fluorescent layer 422 of a decoding optical disc 420; and (c) processor 520 that is connected to data reading optical head 510 and to decoding information reading optical head 520, and which is adapted to decode the coded data into decoded data in response to the decoding information.

According to an embodiment of the invention, system 500 further includes at least one servo 512 that is connected to a data reading optical head 510, and/or at least one servo 522 that is connected to a decoding information reading optical head 520.

According to an embodiment of the invention, optical disc decoding system 500 further includes Interface 590 that includes multiple inputs (not shown) that are connected to optical heads 510 and/or 520, and an output (not shown) that is connected to an analog to digital converter (542).

According to an embodiment of the invention, data reading optical head 510 is adapted to read coded video data from the at least one data layer 412 and wherein processor 530 is adapted to decode the coded video data into video data, in response to the decoding information.

According to an embodiment of the invention, optical disc decoding system 500 further includes video output unit 540, wherein processor 530 is further adapted to provide the video data to video output unit 540 that is adapted to provide a video stream in response to the video data. It is noted that, according to an embodiment of the invention, the video output unit is external to optical disc decoding system 500.

According to an embodiment of the invention, video processing unit 540 includes multiple analogue to digital converters 542 that are connected to at least one video decoder 544; wherein a number of the analog to digital converters exceeds a number of video decoders 544.

According to an embodiment of the invention, optical disc decoding system 500 includes multiple data reading optical heads 510, wherein each of the multiple data reading optical heads 510 is adapted to read coded data from a data layer 512 of a different data optical disc 410 (such as data optical discs 410(1) and 410(2)) selected out of a group of multiple data optical discs, wherein a single data optical disc 410 stores in the one or more data layers 412 of the single data optical disc 410 only a portion of the coded data.

According to an embodiment of the invention, the multiple data reading optical head 510 are connected to at least one analog to digital converter 542 via interface 590; wherein a number of the data reading optical heads 510 exceeds the number of analog to digital converters 542.

According to an embodiment of the invention, the at least one data reading optical head 510 is adapted to read coded data from data layer 412 of data optical disc 410 that is formatted according to a format selected from a group that consists of: DVD-5, DVD-9, DVD-10, DVD-18, HD-DVD, Blue Ray, VMD and FMD.

It is noted that, according to an embodiment of the invention, optical disc decoding system 500 is further adapted to write to data layer 412.

It is clear to a person who is skilled in the art that, conveniently, optical disc decoding system 500 and different embodiments thereof are similar in many aspects to the aforementioned system 17 and the aforementioned different embodiments of which 17′,17″,17′″. Thus, it is clear to a person who is skilled in the art that the at least some aspects of the previously disclosed different embodiments of system 17 could be further implemented in relation to optical disc decoding system 500.

Thus, according to an embodiment of the invention, optical disc decoding system 500 is adapted to retrieve fragment location information and to retrieve coded data fragments in response to fragment location information; wherein at least a portion of the fragment location information is stored on fluorescent layer 422.

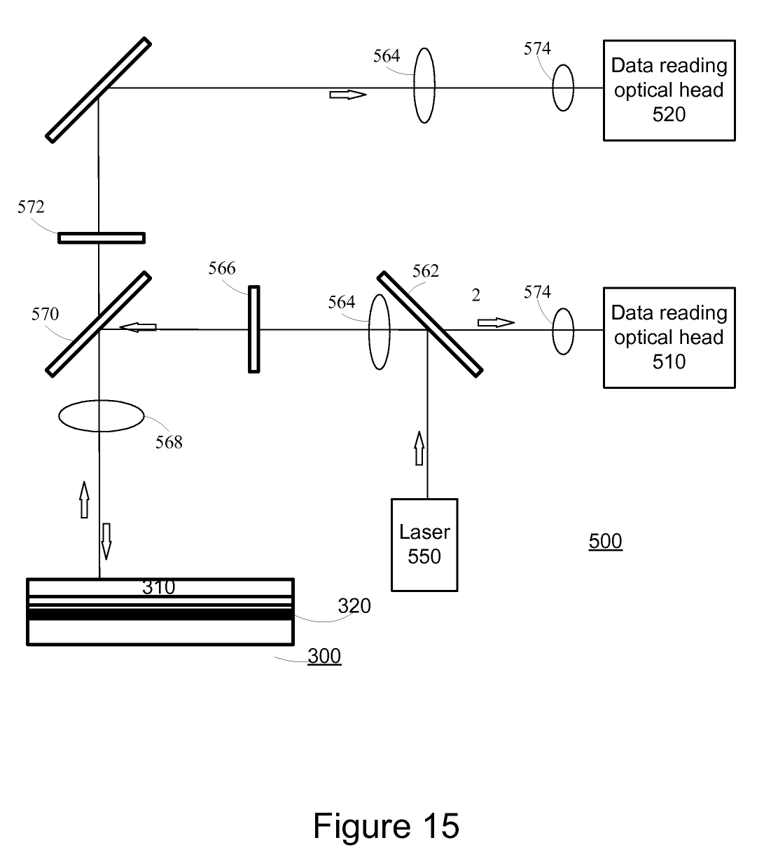

FIG. 15 illustrates optical disc decoding system 500, according to an embodiment of the invention. According to an embodiment of the invention, such as the one illustrated in FIG. 15, data reading optical head 510 is adapted to read coded data from data layer 412 of an optical disc 300 which includes the data layer 310 and the fluorescent layer 320; and decoding information reading optical head 520 is adapted to read decoding information from a fluorescent layer 320 of the optical disc 300.

According to an embodiment of the invention, a laser beam is projected onto optical disc 300 from laser 550 (that is included, according to an embodiment of the invention, in optical disc decoding system 500), wherein the laser beam may be directed onto optical disc 300 by one or more optical components such as Semitransparent mirror 562 and aspherical objective 568, or otherwise optically handled, e.g. by laser collimator 564

According to an embodiment of the invention, optical disc decoding system 500 includes diffraction grating 566 that is adapted to disperses the laser beam so as to provide wavelength adapted to be read by data reading optical head 510 as well as by decoding information reading optical head 520.

The laser beam reflected from optical disc 300 is optically guided towards data reading optical head 510 and toward decoding information reading optical head 520, wherein according to an embodiment of the invention, dichroic mirror 570 of optical disc decoding system 500, separates the wavelengths guided towards data reading optical head 510 from those guided towards decoding information reading optical head 520. According to an embodiment of the invention, at least a portion of the reflected laser beam is filtered by filter 572.

According to an embodiment of the invention, the laser beam which is guided towards one of the optical heads passes through a laser collimator 564, and/or through a lens 574, which is conveniently a sferocylindrical lens. According to an embodiment of the invention, at least one of optical heads 510 and 520 includes a 6-elements photodiode.

According to an embodiment of the invention, optical disc decoding system 500 can read both reflective HD DVD data layers 410 and fluorescent layer 420.

According to an embodiment of the invention, optical disc decoding system 500 is conveniently assembled out of a regular DVD optical head and additional device, which is attached to the former from below and includes standard optical elements, including dichroic mirror and interferential filter, as well as of pin photo diodes (e.g. as described in U.S. Pat. No. 6,009,065 and U.S. Pat. No. 6,992,965).

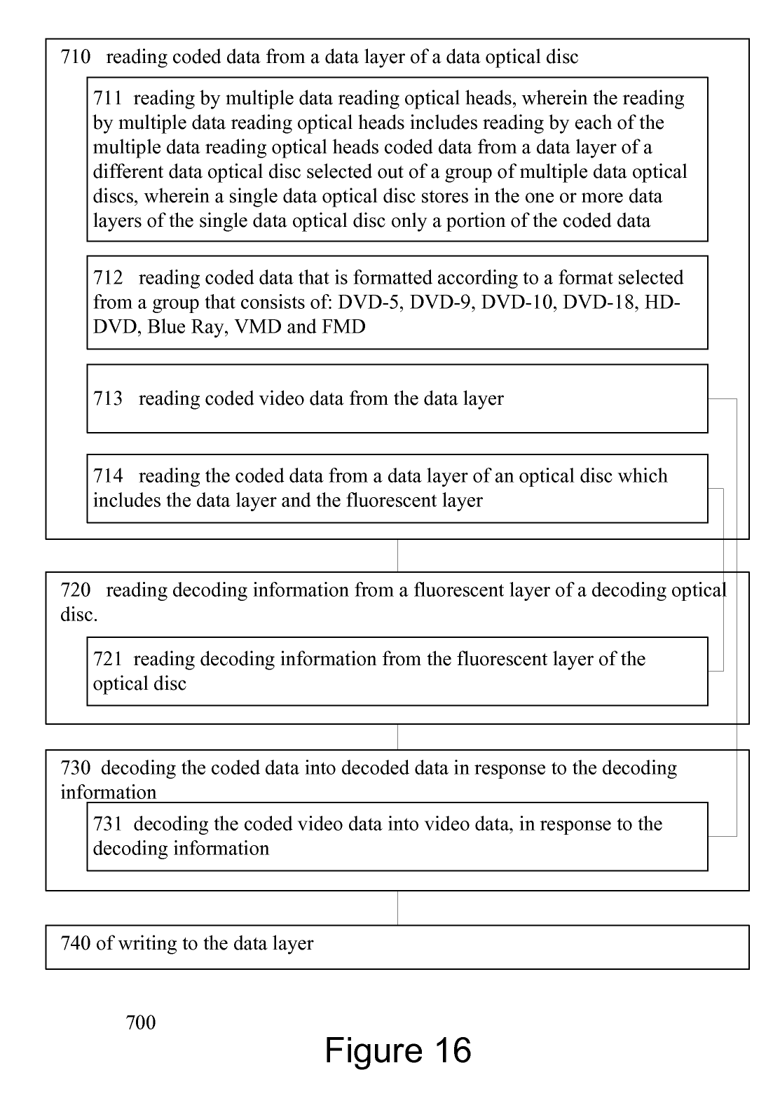

FIG. 16 illustrates method 700 for decoding, according to an embodiment of the invention. Method 700 starts with stage 720 of reading the decoding information from a fluorescent layer of a decoding optical disc.

According to an embodiment of the invention, stage 720 follows stage 721 of decoding information from the fluorescent layer of a decoding optical disc.

Stage 710 of reading coded data from a data layer of a data optical disc follows stage 720 of reading decoding information from the fluorescent layer of the decoding optical disc.

According to an embodiment of the invention, stage 710 includes stage 713 of reading coded video data from the data layer, and stage 730 includes stage 731 of decoding the coded video data into video data, in response to the decoding information.

According to the embodiment of the invention, stage 711 includes stage 711 of reading by multiple data reading optical heads, wherein the reading by multiple data reading optical heads includes reading by each of the multiple of the optical heads coded data from a data layer of a different data optical disc selected out of the group of multiple data optical discs, wherein a single data optical disc stores in the one or more data layers of the single data optical only a portion of the coded data.

Stage 730 of decoding the coded data into decoded data in response to the decoding information is followed by stage 710 of reading coded data from a data layer of a data optical disc.

According to an embodiment of the invention, stage 710 includes stage 712 of reading the coded data that is formatted according to one of the optical disc storage formats,

such as (including but not exhausting): DVD-5, DVD-9, DVD-10, DVD-18, HD-DVD, Blue Ray (BD), VMD.

According to an embodiment of the invention, method 700 further includes stage 740 of writing to the data layer.OK

The present invention can be practiced by employing conventional tools, methodology and components. Accordingly, the details of such tools, component and methodology are not set forth herein in detail. In the previous descriptions, numerous specific details are set forth, in order to provide a thorough understanding of the present invention. However, it should be recognized that the present invention might be practiced without resorting to the details specifically set forth.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

We claim:

1. An optical disc decoding system, the optical disc decoding system comprises:
a data reading optical head that is adapted to read coded data from a data layer of a data optical disc;
a decoding information reading optical head, that is adapted to read decoding information from a fluorescent layer of a decoding optical disc; and
a processor, coupled to the data reading optical head and to the decoding information reading optical head, and which is adapted to decode the coded data into decoded data in response to the decoding information.

2. The optical disc decoding system according to claim 1, wherein the data reading optical head is adapted to read coded data from a data layer of an optical disc which comprises the data layer and the fluorescent layer; and the decoding information reading optical head is adapted to read decoding information from the fluorescent layer of the optical disc.

3. The optical disc decoding system according to claim 1, wherein the data reading optical head is adapted to read coded video data from the data layer, and wherein the processor is adapted to decode the coded video data into video data, in response to the decoding information.

4. The optical disc decoding system, according to claim 3, further comprising a video output unit, wherein the processor is further adapted to provide the video data to the video output unit that is adapted to provide a video stream in response to the video data.

5. The optical disc decoding system, according to claim 4, wherein the video processing unit comprises multiple analogue to digital converters that are coupled to at least one video decoder; wherein a number of analog to digital converters exceeds a number of video decoders.

6. The optical disc decoding system according to claim 1, comprising multiple data reading optical heads, wherein each of the multiple data reading optical heads is adapted to read coded data from a data layer of a different data optical disc selected out of a group of multiple data optical discs, wherein a single data optical disc stores in the one or more data layers of the single data optical disc only a portion of the coded data.

7. The optical disc decoding system according to claim 6, wherein the multiple data reading optical head are coupled to at least one analog to digital converter via an interface; wherein a number of the data reading optical heads exceeds a number of analog to digital converters.

8. The optical disc decoding system according to claim 1, wherein the data reading optical head is adapted to read coded data from the data layer of the data optical disc that is formatted according to a format selected from a group that consists of: DVD-5, DVD-9, DVD-10, DVD-18, HD-DVD, Blue Ray, VMD and FMD.

9. The optical disc decoding system according to claim 1, further adapted to write to the data layer.

10. The optical disc decoding system according to claim 1, adapted to retrieve fragment location information and to retrieve coded data fragments in response to fragment location information; wherein at least a portion of the fragment location information is stored on the fluorescent layer.

11. A method for decoding, the method comprises:
reading coded data from a data layer of a data optical disc;
reading decoding information from a fluorescent layer of a decoding optical disc; and
decoding the coded data into decoded data in response to the decoding information.

12. The method according to claim 11, wherein the reading of the coded data comprises reading the coded data from a data layer of an optical disc which comprises the data layer and the fluorescent layer; and wherein the reading of the decoding information comprises reading decoding information from the fluorescent layer of the optical disc.

13. The method according to claim 11, wherein the reading of the coded data comprises reading coded video data from the data layer, and wherein decoding comprises decoding the coded video data into video data, in response to the decoding information.

14. The method according to claim 11, wherein the reading of the coded data comprises reading by multiple data reading optical heads, wherein the reading by multiple data reading optical heads comprises reading by each of the multiple data reading optical heads coded data from a data layer of a different data optical disc selected out of a group of multiple data optical discs, wherein a single data optical disc stores in the one or more data layers of the single data optical disc only a portion of the coded data.

15. The method according to claim 11, wherein the reading of the coded data comprises reading coded data that is formatted according to a format selected from a group that consists of: DVD-5, DVD-9, DVD-10, DVD-18, HD-DVD, Blue Ray, VMD and FMD.

16. The method according to claim 11, further comprising writing to the data layer.

17. An optical disc, the optical disc comprises: (a) at least one data layer, which comprises coded data, and (b) a fluorescent layer, which comprises decoding information, for the decoding of the coded data.

18. The optical disc according to claim 17, comprising multiple data layers that comprise coded data which is scrambled between the multiple data layers; wherein the fluorescent layer comprises decoding information for the reassembling of the scrambled data.

19. The optical disc according to claim 17, wherein a decoded data that is received from a decoding of coded data in response to the decoding information is a video data.

20. The optical disc according to claim 17, wherein the optical disc is a two-layer optical disc, which is made of two bound substrates, wherein a first substrate which comprises the data layer is a reflective optical disc and a second substrate which comprises the fluorescent layer is a fluorescent disc.

21. The optical disc according to claim 17, wherein a fluorescent dye of the fluorescent layer has an absorption maximum at a laser radiation of wavelength 650-660 nanometers.

22. The optical disc according to claim 17, wherein a fluorescent dye of the fluorescent layer has a secondary radiation maximum substantially at 400 nanometer wavelength.

23. The optical disc according to claim 17, wherein the fluorescent layer stores an essential part of service information that pertains to decoding of the coded data.

24. An optical discs system, comprising at least one data optical disc which comprises at least one data layer that comprises coded data, and a decoding optical disc which comprises a fluorescent layer, which comprises decoding information, for the decoding of the coded data.

25. The optical discs system according to claim 24, wherein multiple data layers of the at least one data optical disc comprise coded data which is scrambled between the multiple data layers; wherein the fluorescent layer comprises decoding information for the reassembling of the scrambled data.
